(19) United States
(12) Patent Application Publication
(10) Pub. No.: US 2012/0207965 A1
(43) Pub. Date: Aug. 16, 2012

(54) BACKPACK WITH INTERCHANGEABLE FACADES

(76) Inventors: Alexandra Higgins, Miramar, FL (US); Layton Higgins, Miramar, FL (US); Ronald Davis, Smyrna, GA (US); Andrew McKellop, Denver, CO (US)

(21) Appl. No.: 13/370,986

(22) Filed: Feb. 10, 2012

Related U.S. Application Data
(60) Provisional application No. 61/442,320, filed on Feb. 14, 2011.

(51) Int. Cl. B32B 3/06

(52) U.S. Cl. 428/100

(57) ABSTRACT

An interchangeable strap facade system for a bag is disclosed. The system includes a strap connected to the bag, a first portion of hook and loop fabric disposed on a first side of the strap; stitching located around a circumference of the first portion, wherein the stitching couples the first portion to the first side of the strap, a removable strap facade having an outward facing side and an inward facing side, wherein the outward facing side comprises a portion of fabric having a design and wherein the inward facing side comprises a second portion of hook and loop fabric, stitching located around a circumference of the second portion, wherein the stitching couples the second portion to the inward facing side of the façade, and wherein the second portion is coupled to the first portion so as to removably couple the strap with the facade.

### CROSS-REFERENCE TO RELATED APPLICATIONS

This utility patent application claims priority to provisional application No. 61/442,320 filed Feb. 14, 2011.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The invention disclosed broadly relates to the field of fashion and clothing accessories, and more particularly relates to the field of straps used with bags and backpacks.

### BACKGROUND OF THE INVENTION

Backpacks, messenger bags and other types of bags using straps that are slung over a user's shoulder have become increasingly common in recent years. One of the drawbacks of these types of bags is that they are difficult to pair or match with changing tastes and fashion. A pink-colored bag may be fashionable today, but next year pink may be out of fashion. But unlike shoes, most individuals do not keep large collections of bags that match different colors. For this reason, most bags come in neutral colors, such as black or brown, so as to allow a user to match the bag or backpack to any of a variety of colors and styles.

Consequently, a need exists to overcome the problems with the prior art as discussed above, and particularly for a more versatile way to use bags and backpacks as accessories.

### SUMMARY OF THE INVENTION

Briefly, according to an embodiment of the present invention, an interchangeable strap facade system for a bag is disclosed. The system includes a strap comprising a strip connected to the bag at both ends; a first portion of hook and loop fabric disposed on a first side of the strap; stitching located around a circumference of the first portion of hook and loop fabric, wherein the stitching couples the first portion of hook and loop fabric to the first side of the strap; a removable strap facade having an outward facing side and an inward facing side, wherein the outward facing side comprises a portion of fabric having a design set therein and wherein the inward facing side comprises a second portion of hook and loop fabric; stitching located around a circumference of the second portion of hook and loop fabric, wherein the stitching couples the second portion of hook and loop fabric to the inward facing side of the removable strap facade; and wherein the second portion of hook and loop fabric is coupled to the first portion of hook and loop fabric, so as to removably couple the strap with the removable strap facade.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 is an illustration of a view of an interchangeable strap facade system for a bag, according to one embodiment of the present invention.

FIG. 2 is an illustration of another view of the bag of FIG. 1.

FIG. 3 is an illustration of a view of an interchangeable strap facade system for a smaller bag, according to one embodiment of the present invention.

### DETAILED DESCRIPTION

The present invention provides an interchangeable strap facade system for a bag wherein multiple facades of various colors and designs can be removably attached to one or more straps of the bag. The present invention is beneficial as it allows a user to purchase only one bag and simply replace the facade(s) with one of a color or design that matches the tastes or clothing of the user. The present invention allows a user to quickly and easily replace the facade(s) of the bag's strap at a whim. This results in a bag that is much more versatile from the fashion perspective. Lastly, the present invention provides a product manufactured from materials that are durable and easily washable. This allows a user to utilize the apparatus of the present invention normally in his or her daily life without having to worry about early wear and tear and stains.

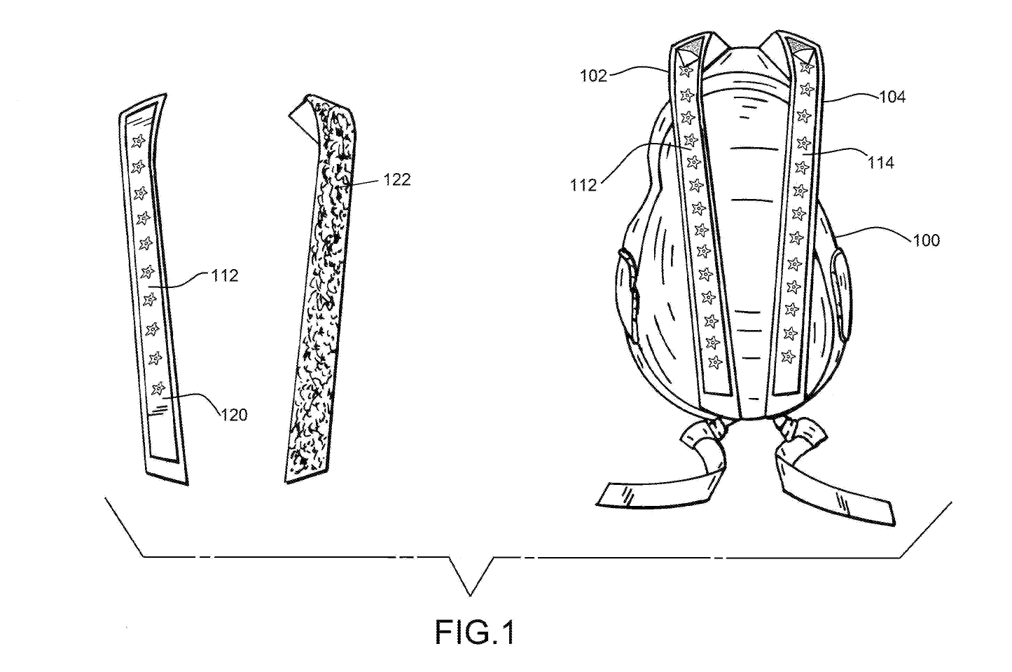

FIG. 1 is an illustration of a view of an interchangeable strap facade system for a bag 100 according to one embodiment of the present invention. The bag 100 comprises a conventional backpack including two shoulder straps 102, 104. FIG. 1 shows the strap 102 and the strap 104 each comprise a strip that is connected to the bag 100 at both ends.

The straps 102, 104 each include a first portion of hook and loop fabric disposed on an outward facing side of the strap. Stitching may be located around a circumference of the first portion of hook and loop fabric, wherein the stitching couples the hook and loop fabric to the outward facing side of the straps 102, 104. Stitching may also be located within a circumference of the first portion of hook and loop fabric, so as to further secure the hook and loop fabric to the outward facing side of the straps 102, 104. In one embodiment, the first portion of hook and loop fabric may be the hook portion of fabric. Other methods of attaching the hook and loop fabric to the outward facing side of the straps 102, 104 may be used, such as adhesives and the use of a fastener such as a snap. In another embodiment, border stitching may be located around a circumference of the first portion of hook and loop fabric. In yet another embodiment, the first portion of hook and loop fabric and each strap, 102, 104 are integrally woven together.

FIG. 1 shows that removable strap facades 112, 114 have been removably attached to straps 102, 104, respectively. The facades 112, 114 include, by way of example, a surface design including decorative stars.

FIG. 1 also shows a removable strap facade 112 having an outward facing side (shown as surface 120) and an inward facing side 122, wherein the outward facing side comprises a portion of fabric having a design set therein and wherein the inward facing side comprises a second portion of hook and loop fabric, which may be the loop portion of fabric. The outward facing side 120 may have a design set therein via any one of embroidery, screen printing, dye printing or any combination thereof. Stitching may be located around a circumference of the second portion of hook and loop fabric, wherein the stitching couples the hook and loop fabric to the inward facing side 122 of the removable strap facade 112. Other methods of attaching the hook and loop fabric to the inward facing side 122 of the removable strap facade 112 may be used, such as adhesives and the use of a fastener such as a snap. In another embodiment, border stitching may be located around a circumference of the second portion of hook and loop fabric. In yet another embodiment, the second portion of hook and loop fabric and the facade 112 are integrally woven together.

The second portion of hook and loop fabric is coupled to the first portion of hook and loop fabric, so as to removably couple the strap 102 with the removable strap facade 112. That is, the hook portion of strap 102 is removably attached to the loop portion of side 122 of facade 120. In this way, multiple facades of various colors and designs can be removably attached to the straps 102, 104 of the bag 100.

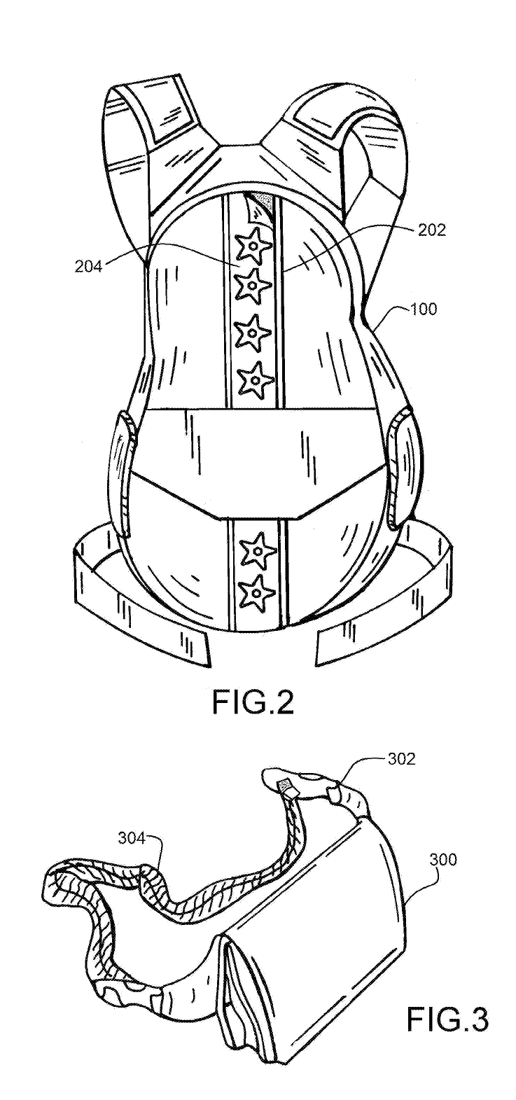

FIG. 2 is an illustration of a frontal view of the bag 100 of FIG. 1. FIG. 2 shows the front side of the bag 100 of FIG. 1, which shows a second implementation wherein a removable facade 204 may be removably attached to the middle area 202 of the front face of the bag 100. The front face of the bag 100 may include a portion of hook and loop fabric disposed on an outward facing side of the bag 100. Stitching may be located around a circumference of the portion of hook and loop fabric, wherein the stitching couples the hook and loop fabric to the outward facing side of the front face of the bag 100.

FIG. 2 also shows a removable facade 204 having an outward facing side and an inward facing side, wherein the outward facing side comprises a portion of fabric having a design set therein and wherein the inward facing side comprises a second portion of hook and loop fabric. Stitching may be located around a circumference of the second portion of hook and loop fabric, wherein the stitching couples the hook and loop fabric to the inward facing side of the removable strap facade 204. Subsequently, the second portion of hook and loop fabric of the facade 204 is coupled to the first portion of hook and loop fabric on the bag 100.

FIG. 3 is an illustration of a view of an interchangeable strap facade system for a fanny pack bag 300 according to one embodiment of the present invention. The fanny pack bag 300 includes a single strap 302 that may include a removable strap facade 304, as described above with reference to FIGS. 1 and 2.

One or more of the components of the bags 100, 30, the straps 102, 104, 302 and the facades 112, 114, 204, 304 may be composed of a variety of textiles or cloths. The textile or cloth can be any manner of flexible woven material consisting of a network of natural or artificial fibers. The textiles can be made from any of a variety of materials, including animal (wool, silk), plant (cotton, flax, jute), mineral (asbestos, glass fiber), and synthetic (nylon, polyester, acrylic).

The textiles from which the one or more of the components of the bags 100, 30, the straps 102, 104, 302 and the facades 112, 114, 204, 304 may be manufactured in a variety of different ways, including weaving, knitting, spread tow, braising or felting. Weaving is a textile production method which involves interlacing a set of longer threads with a set of crossing threads. Mechanized knitting and crocheting involve interlacing loops of yarn, which are formed either on a knitting needle or on a crochet hook, together in a line. Spread tow is a production method where the yarn are spread into thin tapes, and then the tapes are woven as warp and weft. Braiding or plaiting involves twisting threads together into cloth. Knotting involves tying threads together and is used in making macrame. Felting involves pressing a mat of fibres together, and working them together until they become tangled. Nonwoven textiles are manufactured by the bonding of fibres to make fabric. Bonding may be thermal or mechanical, or adhesives can be used.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. An interchangeable strap facade system for a bag, comprising:
a strap comprising a strip connected to the bag at both ends;
a first portion of hook and loop fabric disposed on a first side of the strap;
stitching located around a circumference of the first portion of hook and loop fabric, wherein the stitching couples the first portion of hook and loop fabric to the first side of the strap;
a removable strap facade having an outward facing side and an inward facing side, wherein the outward facing side comprises a portion of fabric having a design set therein and wherein the inward facing side comprises a second portion of hook and loop fabric;
stitching located around a circumference of the second portion of hook and loop fabric, wherein the stitching couples the second portion of hook and loop fabric to the inward facing side of the removable strap facade; and
wherein the second portion of hook and loop fabric is coupled to the first portion of hook and loop fabric, so as to removably couple the strap with the removable strap facade.

2. The interchangeable strap facade system of claim 1, further comprising stitching located within the circumference of the first portion of hook and loop fabric, wherein the stitching couples the first portion of hook and loop fabric to the first side of the strap.

3. The interchangeable strap facade system of claim 2, wherein the outward facing side of the removable strap facade comprises a portion of fabric having a design set therein via any one of embroidery, screen printing, dye printing or any combination thereof.

4. The interchangeable strap facade system of claim 3, wherein the first portion of hook and loop fabric and the strap are integrally woven together.

5. The interchangeable strap facade system of claim 4, wherein the strap comprises border stitching around a circumference of the strap.

6. The interchangeable strap facade system of claim 1, further comprising:
a second strap comprising a strip connected to the bag at both ends;
a third portion of hook and loop fabric disposed on a first side of the second strap;
stitching located around a circumference of the third portion of hook and loop fabric, wherein the stitching couples the third portion of hook and loop fabric to the first side of the second strap;
a second removable strap facade having an outward facing side and an inward facing side, wherein the outward facing side comprises a portion of fabric having a design set therein and wherein the inward facing side comprises a fourth portion of hook and loop fabric;
stitching located around a circumference of the fourth portion of hook and loop fabric, wherein the stitching couples the fourth portion of hook and loop fabric to the inward facing side of the second removable strap facade; and
wherein the fourth portion of hook and loop fabric is coupled to the third portion of hook and loop fabric, so as to removably couple the second strap with the second removable strap facade.

7. The interchangeable strap facade system of claim 6, further comprising stitching located within the circumference of the third portion of hook and loop fabric, wherein the stitching couples the third portion of hook and loop fabric to the first side of the second strap.

8. The interchangeable strap facade system of claim 7, wherein the outward facing side of the second removable strap facade comprises a portion of fabric having a design set therein via any one of embroidery, screen printing, dye printing or any combination thereof.

9. The interchangeable strap facade system of claim 8, wherein the third portion of hook and loop fabric and the second strap are integrally woven together.

10. The interchangeable strap facade system of claim 9, wherein the second strap comprises border stitching around a circumference of the second strap.

11. An interchangeable strap facade system for a bag, comprising:
a strap connected to the bag at both ends;
a hook portion of hook and loop fabric disposed on a first side of the strap;
stitching located around a circumference of the hook portion, wherein the stitching couples the hook portion to the first side of the strap;
a removable facade, wherein an outward facing side of the facade comprises a portion of fabric having a design set therein and wherein an inward facing side of the facade comprises a loop portion of hook and loop fabric;
stitching located around a circumference of the loop portion, wherein the stitching couples the loop portion to the inward facing side of the removable facade; and
wherein the loop portion is coupled to the hook portion, so as to removably couple the strap with the removable facade.

12. The interchangeable strap facade system of claim 11, further comprising stitching located within the circumference of the hook portion, wherein the stitching couples the hook portion to the first side of the strap.

13. The interchangeable strap facade system of claim 12, wherein the outward facing side of the removable facade comprises a portion of fabric having a design set therein via any one of embroidery, screen printing, dye printing or any combination thereof.

14. The interchangeable strap facade system of claim 13, wherein the hook portion and the strap are integrally woven together.

15. The interchangeable strap facade system of claim 14, wherein the strap comprises border stitching around a circumference of the strap.

16. The interchangeable strap facade system of claim 15, further comprising:
a second strap connected to the bag at both ends;
a hook portion of hook and loop fabric disposed on a first side of the second strap;
stitching located around a circumference of the hook portion, wherein the stitching couples the hook portion to the first side of the second strap;
a second removable facade, wherein an outward facing side of the facade comprises a portion of fabric having a design set therein and wherein the inward facing side comprises a loop portion of hook and loop fabric;
stitching located around a circumference of the loop portion, wherein the stitching couples the loop portion to the inward facing side of the second removable facade; and
wherein the loop portion is coupled to the hook portion, so as to removably couple the second strap with the second removable facade.
